(19) United States
(12) Patent Application Publication
(10) Pub. No.: US 2018/0316998 A1
(43) Pub. Date: Nov. 1, 2018

(54) VOICE INFORMATION ACQUISITION APPARATUS

(71) Applicant: OLYMPUS CORPORATION, Tokyo (JP)

(72) Inventor: Junichi UCHIDA, Sagamihara-shi (JP)

(73) Assignee: OLYMPUS CORPORATION, Tokyo (JP)

(21) Appl. No.: 15/956,944

(22) Filed: Apr. 19, 2018

(30) Foreign Application Priority Data
Apr. 28, 2017 (JP) 2017-090488

(51) Int. Cl. H04R 1/08; H04R 1/32

(52) U.S. Cl. CPC H04R 1/086; H04R 1/326

(57) ABSTRACT

A voice information acquisition apparatus includes: a microphone configured to collect voice; a casing configured to house the microphone inside thereof; and a multi-layer filter arranged on a front face of the casing and including at least a three-layer filter that includes a mesh-like first filter arranged on a front face side and a mesh-like second filter arranged on a side facing the microphone.

### CROSS-REFERENCE TO RELATED APPLICATION

This application is based upon and claims the benefit of priority from Japanese Patent Application No. 2017-090488, filed on Apr. 28, 2017, the entire contents of which are incorporated herein by reference.

### BACKGROUND

The present disclosure relates to a voice information acquisition apparatus that acquires voice information.

In the related art, a technique in which when voice is to be recorded with a microphone, directional voice is acquired by combining signal processing for reducing influence of noise coming from undesired directions and directional sensitivity of the microphone has been known. For example, JP 2004-536536 A discloses a technique for using one or more microphones, each having directional sensitivity including a main lobe oriented in a direction other than a specific direction and a back lobe oriented in a specific direction of interest, to reduce influence of sounds that are received by a signal processing circuit from the direction of the main lobe.

### SUMMARY

A voice information acquisition apparatus according to one aspect of the present disclosure includes: a microphone configured to collect voice; a casing configured to house the microphone inside thereof; and a multi-layer filter arranged on a front face of the casing and including at least a three-layer filter that includes a mesh-like first filter arranged on a front face side and a mesh-like second filter arranged on a side facing the microphone.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view illustrating an external appearance of a front side of a voice information acquisition apparatus according to a first embodiment;

FIG. 2 is a perspective view illustrating an external appearance of a back side of the voice information acquisition apparatus according to the first embodiment;

FIG. 3 is a partial cross-sectional view illustrating a configuration of a voice collection unit of the voice information acquisition apparatus according to the first embodiment;

FIG. 4 is a diagram schematically illustrating how voice passes through, as a flow of air, a multi-layer filter;

FIG. 5 is a diagram for explaining a structural advantage of the voice information acquisition apparatus according to the first embodiment;

FIG. 6 is a block diagram illustrating a functional configuration of a voice processing system including the voice information acquisition apparatus according to the first embodiment;

FIG. 7 is a diagram schematically illustrating a configuration of a document generated by a documenting unit of a voice information processing apparatus;

FIG. 8 is a flowchart illustrating an outline of a process performed by the voice processing system;

FIG. 9 is a partial cross-sectional view illustrating a configuration of a main part of a voice information acquisition apparatus according to a first modification of the first embodiment;

FIG. 10 is a partial cross-sectional view illustrating a configuration of a main part of a voice information acquisition apparatus according to a second modification of the first embodiment; and

FIG. 11 is a partial cross-sectional view illustrating a configuration of a main part of a voice information acquisition apparatus according to a second embodiment.

### DETAILED DESCRIPTION

Modes for carrying out the present disclosure (hereinafter, referred to as “embodiments”) will be described below with reference to the drawings. The drawings are only schematic.

A voice information acquisition apparatus according to an embodiment includes: a microphone configured to collect voice; a casing configured to house the microphone inside thereof; and a multi-layer filter arranged on a front face of the casing and including at least a three-layer filter that includes a mesh-like first filter arranged on a front face side and a mesh-like second filter arranged on a side facing the microphone. The multi-layer filter and the microphone are separated from each other by a distance that is determined according to an effect that voice noise, which occurs when the multi-layer filter disperses and absorbs air, and voice, which has passed through the multi-layer filter, are attenuated with distance. The voice information acquisition apparatus is adopted for a medical purpose for example, and is used when a user, such as a doctor, inputs voice to generate a medical record while viewing a diagnosis result. In this case, the user inputs voice to the microphone while holding the voice information acquisition apparatus in a user's hand. The voice information acquisition apparatus according to the embodiments may be adopted for other purposes other than the medical purpose.

### First Embodiment

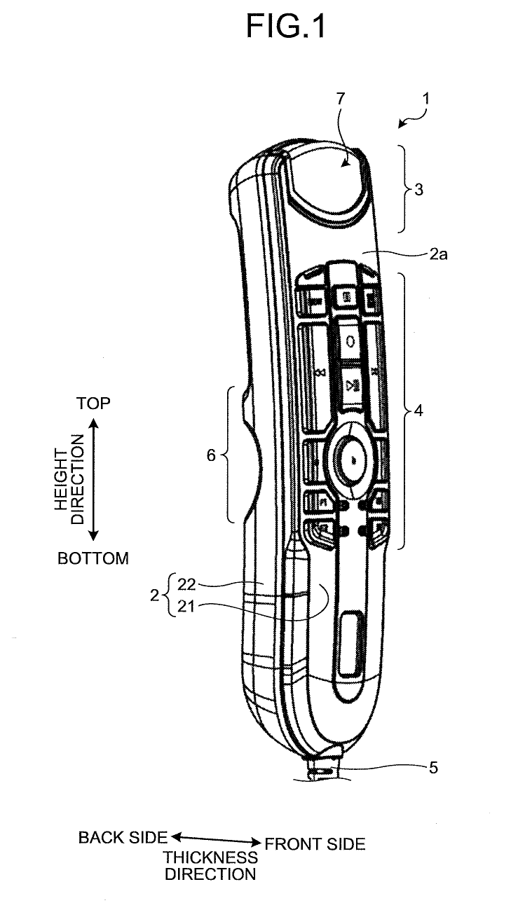

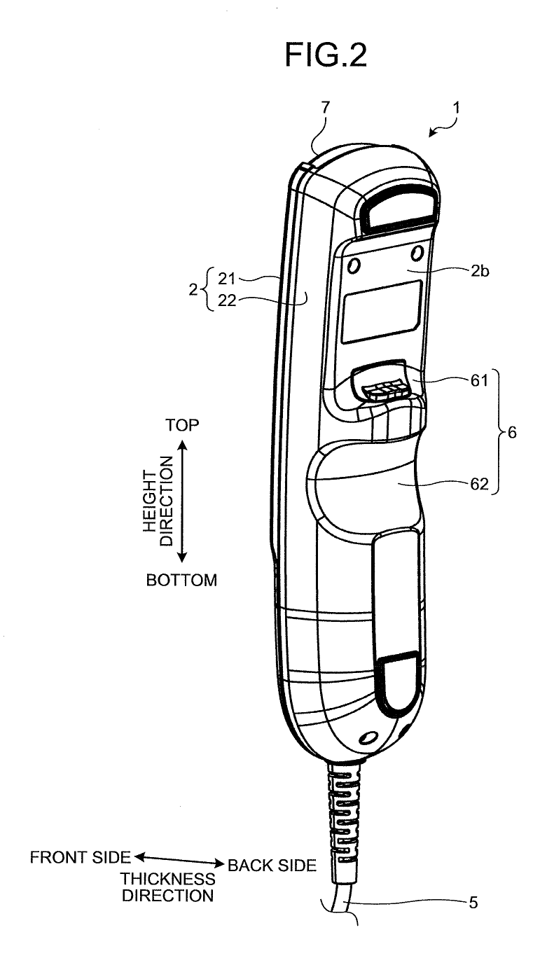

FIG. 1 is a perspective view illustrating an external appearance of a front side of a voice information acquisition apparatus according to a first embodiment. FIG. 2 is a perspective view illustrating an external appearance of a back side of the voice information acquisition apparatus according to the first embodiment. A voice information acquisition apparatus 1 illustrated in FIG. 1 and FIG. 2 is an apparatus that collects voice generated outside the apparatus, and generates voice information. The voice information acquisition apparatus 1 includes a casing 2, a voice collection unit 3, an operating unit 4, and a connector code 5.

The casing 2 is a structure including a first casing 21 on a front side and a second casing 22 on a back side, and houses the voice collection unit 3 and various electronic components for implementing functions of the voice information acquisition apparatus 1. As illustrated in FIG. 1, the casing 2 has a substantially rectangular solid shape, i.e., a vertically elongated shape in a state of being held in the user's hand. The casing 2 has such a size that approximately half of the casing in the height direction (the vertical direction in FIG. 1 and FIG. 2) fits in the palm of the user's hand in a state of being held in the user's hand. Further, the casing 2 has such a thickness that a back face 2b of the second casing 22 may be held with the forefinger and the pinky finger when the user places the thumb on a front face 2a of the first casing 21.

A finger holder 6, on which a finger is held when the user holds the casing 2 in the user's hand, is provided in an approximately central part of the second casing 22 in the height direction. As illustrated in FIG. 2, the finger holder 6 includes two recesses 61 and 62 in an upper part and a lower part in the height direction. The user holds fingers other than the thumb on the two recesses 61 and 62 as appropriate to hold the casing 2 together with the thumb placed on the front face 2a of the first casing 21.

The casing 2 is not limited to the structure including the two members such as the first casing 21 and the second casing 22, but may be a structure including a combination of three or more members. For example, a frame member (a frame for filters) that forms the shape of the voice collection unit 3 may be included in the casing 2. Further, the front face 2a side of the first casing 21 may be formed in a curved surface shape or a flat surface shape along the height direction in FIG. 1.

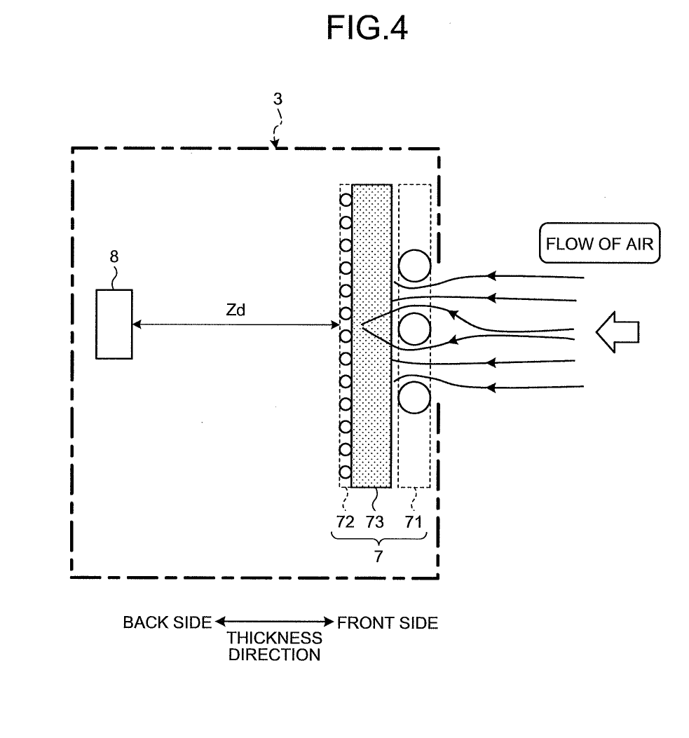

The voice collection unit 3 is provided in an upper end portion of the casing 2 in the height direction, and has a function to collect voice. The voice collection unit 3 includes a multi-layer filter 7 that eliminates various kinds of noise including noise included in voice, and a microphone 8 that is housed inside the casing 2 and collects voice that propagates via the multi-layer filter 7. A detailed configuration of the voice collection unit 3 will be described later with reference to FIG. 4.

The operating unit 4 includes a plurality of buttons provided on the front face 2a side of the casing 2. Examples of the buttons include a recording button and a replay button. As illustrated in FIG. 1, the operating unit 4 is a plurality of buttons that protrude more than the front face 2a from the first casing 21, and that are provided in and around a central part of the first casing 21 in the height direction. The user operates the operating unit 4 with the thumb placed on the operating unit 4 arranged on the front face 2a side while holding the casing 2. It may be possible to provide, on at least one of the two recesses 61 and 62 of the second casing 22, a member, such as a button, that serves as a part of the operating unit 4.

The connector code 5 is connected to an external apparatus, and configured to output voice information to the external apparatus and receive a signal from the external apparatus. The voice information acquisition apparatus 1 may be connected to an external apparatus so as to be able to communicate with the external apparatus by radio.

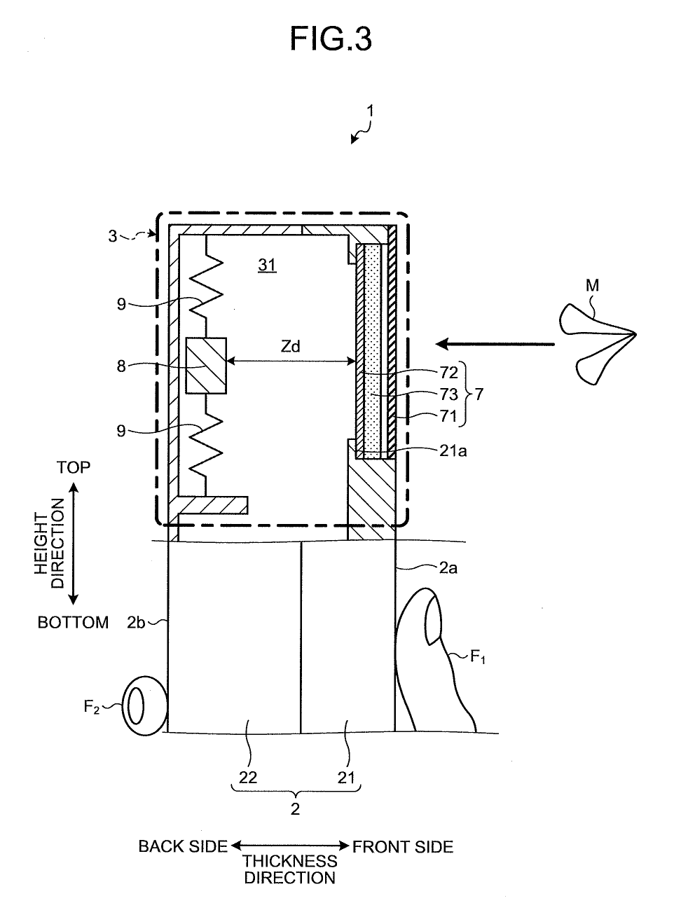

FIG. 3 is a partial cross-sectional view illustrating a configuration of the voice collection unit 3 of the voice information acquisition apparatus 1. As illustrated in FIG. 3, the voice collection unit 3 includes the multi-layer filter 7 that is mounted on the front face 2a of the first casing 21 and has a three-layer structure, and the microphone 8 that is mounted on a housing part 31 provided inside the casing 2. In FIG. 3, a transmission direction of voice output through a mouth M of a user is indicated by an arrow. An angle of the transmission direction with respect to the front face 2a of the first casing 21 is about 0 degrees. Further, FIG. 3 illustrates a user's holding state by illustration of a thumb F₁ and a forefinger F₂.

The multi-layer filter 7 includes a first filter 71 that serves as a part of an outer surface of the voice information acquisition apparatus 1 (an outer surface on the front face 2a side), a second filter 72 that faces the microphone 8, and a third filter 73 that is arranged between the first filter 71 and the second filter 72. The multi-layer filter 7 has a function to block a part of a flow of air that is blown into the voice collection unit 3 with plosives spoken by the user and to disperse or absorb the part of the flow of air, to thereby prevent noise that occurs when air directly hits the microphone 8.

The first filter 71 is configured with a sheet-like metal mesh, and serves as a part of the outer surface of the voice information acquisition apparatus 1. Therefore, grease (sebum) from hands may adhere to the first filter 71 due to contact with the user's hand. If a diameter of a wire that forms the mesh of the first filter 71 is small, and a mesh opening that is a size of spacing between adjacent wires is excessively small, dirt due to the adhered sebum may become visible. Therefore, it is preferable that the first filter 71 has a mesh opening that is less likely to cause sebum dirt to become visible. Further, the first filter 71 needs to have appropriate strength because the first filter 71 serves as a part of the outer surface. The wire diameter and the mesh opening of the mesh of the first filter 71 are set in consideration of the foregoing. The first filter 71 is not necessarily formed in a flat sheet shape, but may be formed in a curved sheet shape such that the curve is extended from the front side to an upper end side in the upper end portion of the casing 2, for example.

The second filter 72 is configured with a sheet-like metal mesh, similarly to the first filter 71. A mesh opening of the second filter 72 is smaller than the mesh opening of the first filter 71, and a wire diameter of the second filter 72 is smaller than the wire diameter of the first filter 71. Further, a product of the wire diameter and the number of wires of the second filter 72 per unit area is smaller than a product of the same factors of the first filter 71. In general, a pop-noise reduction effect increases with a decrease in the mesh opening. Therefore, the second filter 72 is a filter that has a higher pop-noise reduction effect than the first filter 71.

The third filter 73 is configured with a non-woven cloth, and is a sheet-like filter that is thicker than the first filter 71 and the second filter 72. The pop-noise reduction effect increases with an increase in the thickness of the third filter 73. The third filter 73 is separated from the first filter 71, but is in contact (close contact) with the second filter 72. Air that is dispersed while passing through the first filter 71 hits the third filter 73. The first filter 71 and the third filter 73 may be in contact with each other. As a result, the third filter 73 absorbs energy caused by the air hitting, and attenuates a hitting sound. It is confirmed that when the thickness of the third filter 73 in the layer direction is equal to or smaller than 1 millimeter (mm), or more preferably, about 0.9 mm, the frequency characteristic and sensitivity of the microphone 8 are little affected. The size of the principal surface of the third filter 73 may be the same as the size of the principal surface of the second filter 72, or may be different from the size of the principal surface of the second filter 72.

The second filter 72 and the third filter 73 are mounted on a filter housing recess 21a that has a quadrilateral shape and is provided in an upper part of the first casing 21 in the height direction. The filter housing recess 21a is recessed from the front face 2a of the first casing 21 toward the microphone 8. The shape of the filter housing recess 21a is not limited to the quadrilateral shape. That is, the second filter 72 and the third filter 73 are not limited to the quadrilateral sheets.

It is sufficient that the multi-layer filter 7 has at least three layers, and it may be possible to further provide another layer between the first filter 71 and the second filter 72. Further, the magnitude relationship of the mesh opening between the first filter 71 and the second filter 72 may be inverted. That is, even when the mesh opening of the first filter 71 is smaller than the mesh opening of the second filter 72, it is possible to achieve the same performance as that of the multi-layer filter 7 as described above.

The microphone 8 is an omnidirectional microphone, and collects voice that is transmitted from outside via the multi-layer filter 7. The microphone 8 is arranged such that a diaphragm faces the front face 2a (the first casing 21) side of the casing 2 inside the housing part 31. The microphone 8 is mounted in a position separated from the multi-layer filter 7 and located relatively on the back face 2b side of the second casing 22 in the thickness direction of the casing 2 (in the horizontal direction in FIG. 4). Elastic holding members 9 are mounted in an upper part and a lower part of the microphone 8 in the longitudinal direction. In the example illustrated in FIG. 4, the microphone 8 is arranged along the longitudinal direction of the casing 2 so as to be parallel to the multi-layer filter 7 in the height direction. For example, the diaphragm included in the microphone 8 is arranged parallel to the longitudinal direction of the casing 2. That is, the microphone 8 is arranged such that a line connecting the multi-layer filter 7 and the diaphragm at the shortest distance becomes perpendicular to the diaphragm. The microphone 8 may be configured to have directivity.

The multi-layer filter 7 and the microphone 8 are separated from each other by a predetermined distance Zd in the housing part 31. Hereinafter, the predetermined distance Zd will be referred to as a microphone depth. The microphone depth Zd is 10 to 20 mm. With this configuration, it is possible to eliminate pop noise, which is caused by the voice collection unit 3, with accuracy, and prevent an increase in the size of the casing 2. It is confirmed that the pop-noise reduction effect is further increased if the microphone depth Zd is set to 15 to 20 mm, and such setting is more preferable. The multi-layer filter 7 has a function to block a part of a flow of air that is blown into the voice collection unit 3 with plosives spoken by the user and to disperse or absorb the part of the flow of air, to thereby prevent noise that occurs when air directly hits the microphone 8. A distance by which sounds that occur due to vibration, deformation, or the like of the multi-layer filter 7 are attenuated corresponds to the microphone depth Zd. If an aperture of the voice collection unit 3 is about 10 mm×30 mm (may be defined by the size of the third filter 73) and a distance between the mouth of the user and the voice information acquisition apparatus 1 is about 10 centimeters (cm), it is preferable to set the microphone depth Zd to about this distance (10 cm). It is better to increase the distance, but if the distance is excessively increased, vibration of voice passing through the multi-layer filter 7 is attenuated and the size of the apparatus is increased; therefore, it is preferable to set the distance in consideration of the foregoing. Here, with a decrease in the size of a hole of the third filter 73, an energy dispersion effect is increased, vibration occurs at higher frequency, and a noise sound attenuation effect may be increased with distance. Further, with a decrease in the size of the hole of the third filter 73, the microphone depth Zd may be reduced and measures against a pop sound may be taken effectively with a reduced space. While it depends on the breath of an expected user, it is confirmed that a beneficial effect may be achieved when the microphone depth Zd (a separate distance between the multi-layer filter 7 and the microphone 8) is set to 100 to 500 times the diameter of a filter hole; therefore, it is preferable to design a value in this range. For example, it may be possible to adopt the third filter 73 with a hole of about 50 micrometers (μm) (an aperture ratio of about 28%). By adopting the third filter 73 configured as described above, a part of the breath that may cause a pop sound is blocked, and energy for arrival at the microphone 8 may be reduced.

The elastic holding members 9 are members that hold and fix the microphone 8 onto the casing 2, and that prevent vibration of the casing 2 from being transmitted to the microphone 8. The vibration transmitted from the casing 2 to the microphone 8 includes not only a shock applied to the casing 2 but also a sound that propagates through the casing 2. The sound that propagates through the casing 2 includes what is called touch noise caused by a sound that occurs when the user strokes the outer surface of the casing 2 (the front face 2a, the back face 2b, or a side face). The elastic holding members 9 absorb the touch noise and prevent the touch noise from being collected by the microphone 8.

While the elastic holding members 9 are illustrated in the form of springs in FIG. 3, this is by way of schematic example only, and it may be possible to mount an elastic member in the form of a hollow cylinder onto the housing part 31 and set the microphone 8 in the hollow portion of the elastic member. Further, the elastic holding members 9 may be mounted on the first casing 21 as long as the microphone 8 may be arranged in a position separated from the multi-layer filter 7 by the predetermined distance inside the housing part 31.

Furthermore, it may be possible to apply coating, such as ultraviolet curable resin, to the outer surface of the casing 2 in order to prevent occurrence of touch noise. With this configuration, the outer surface of the casing 2 becomes smooth, and occurrence of touch noise may be prevented even when a user slides a user's finger on the outer surface.

FIG. 4 is a diagram schematically illustrating how voice passes through, as a flow of air, the multi-layer filter 7. As illustrated in FIG. 4, a compressional wave that transmits voice output by the user passes through, as the flow of air (air current), the first filter 71, so that pop noise is reduced. Air that has passed through the first filter 71 is dispersed and air shock occurs. The third filter 73 is located in a position where the air shock occurs; therefore, the third filter 73 absorbs shock energy of the air current and attenuates a hitting sound. Air that has passed through the third filter 73 passes through the second filter 72, so that pop noise is further reduced. The second filter 72 and the microphone 8 are separated from each other by the microphone depth Zd, so that disturbance of the air current of the voice collected by the microphone 8 is attenuated. The microphone depth Zd is determined according to an effect that voice noise, which occurs when the multi-layer filter 7 disperses and absorbs breath when plosives or the like occur, and person's voice that has passed through the multi-layer filter 7, are attenuated with distance. That is, it may be possible to select, as the microphone depth Zd, a distance by which person's voice is not attenuated but pop noise is fully attenuated. Here, it is assumed that attenuation of person's voice due to the above-described dispersion effect is negligible.

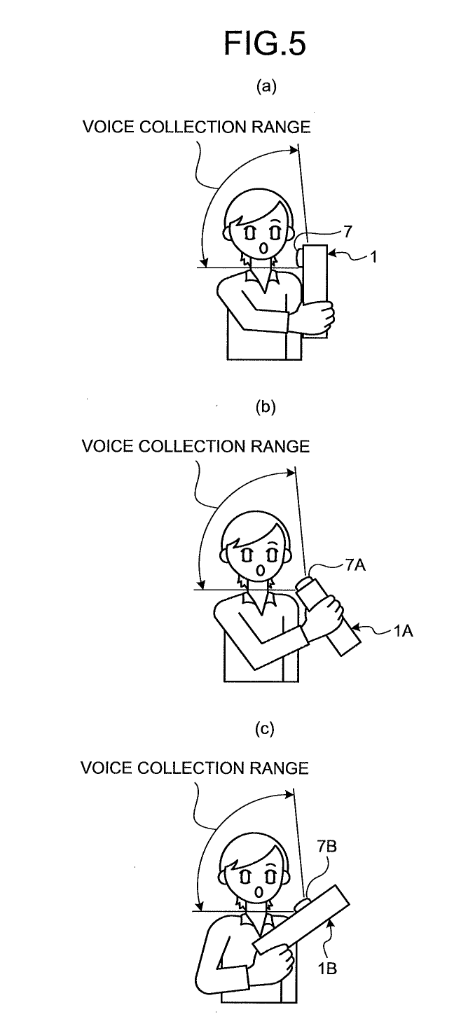

Next, with reference to FIG. 5(a) to (c), a structural advantage of the voice information acquisition apparatus 1 configured as above will be described. As illustrated in FIG. 5(a), when a user outputs voice to record the voice while holding the voice information acquisition apparatus 1 in the user's hand, it is most natural for the user to place a voice input position of the voice information acquisition apparatus 1, i.e., the position of the multi-layer filter 7, in a closer position around the front of the mouth of the user, and to hold the voice information acquisition apparatus 1 without bending the wrist. In this case, the user's hand holding the voice information acquisition apparatus 1 is located at approximately the same height as the chest of the user. In this case, a compressional wave corresponding to the voice output through the mouth of the user is incident on the multi-layer filter 7 from a substantially front side of the front face 2a of the first casing 21. The multi-layer filter 7 (the voice collection unit 3) is located in the upper end portion of the voice information acquisition apparatus 1 in the height direction as described above; therefore, the user may input voice while maintaining a natural and less stressful posture.

In contrast, the user may need to take an unnatural posture depending on a mounting position of the multi-layer filter 7 (the voice collection unit 3). For example, as illustrated in FIG. 5(b), in a case of a voice information acquisition apparatus 1A in which a voice collection filter 7A is provided on a top face of a casing, the user outputs voice toward the voice collection filter 7A while inclining the voice information acquisition apparatus 1A such that an upper portion of the casing is located closer to the user so that the voice collection filter 7A faces the mouth, and such that a bottom portion of the casing is located away from the user. In this case, the user needs to hold the voice information acquisition apparatus 1A in an inclined manner, and therefore needs to take a posture that puts stress on the wrist and the elbow. Furthermore, as illustrated in FIG. 5(c), in a case of a voice information acquisition apparatus 1B in which a voice collection filter 7B is mounted in an approximately central part of a front face of a casing in the height direction, the user needs to hold the voice collection filter 7B in an unstable manner such that the mouth is located in a voice collection range, which increases stress on the user.

As described above, the voice information acquisition apparatus 1 according to the first embodiment is configured such that the voice collection unit 3 is provided in an appropriate less-stressful position in accordance with a user's holding state, and has ergonomically excellent structural characteristics.

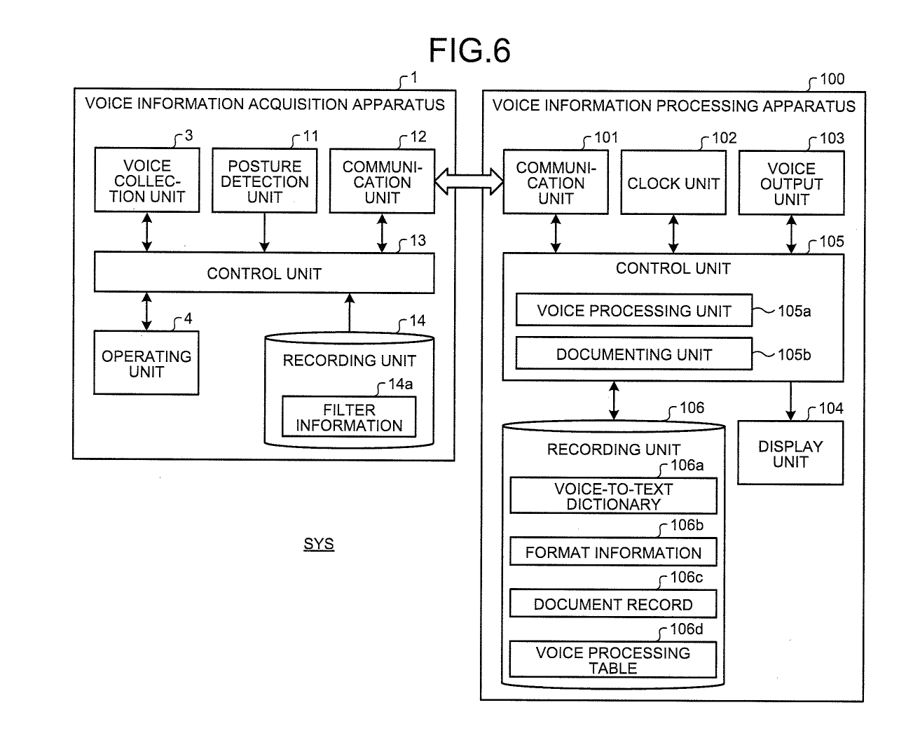

FIG. 6 is a block diagram illustrating a functional configuration of a voice processing system that generates a document by converting voice information acquired by the voice information acquisition apparatus 1 to text information. A voice processing system SYS illustrated in the drawing includes the voice information acquisition apparatus 1 and a voice information processing apparatus 100 that is communicably connected to the voice information acquisition apparatus 1 and generates a document including text information corresponding to voice information. The voice processing system SYS allows a user, such as a doctor, to input voice to the voice information acquisition apparatus 1 and generates a document that may be available as a medical record based on the voice information, for example. The voice processing system SYS may have a function to convert the acquired voice information to text information in parallel to input of voice.

First, a functional configuration of the voice information acquisition apparatus 1 will be described. The voice information acquisition apparatus 1 includes the voice collection unit 3, an operating unit 4, a posture detection unit 11, a communication unit 12, a control unit 13, and a recording unit 14.

The posture detection unit 11 detects a posture of the voice information acquisition apparatus 1. The posture detection unit 11 is configured with an acceleration sensor, for example.

The communication unit 12 transmits and receives information to and from the voice information processing apparatus 100. The communication unit 12 transmits the voice information to the voice information processing apparatus 100 under the control of the control unit 13. The voice information acquisition apparatus 1 illustrated in FIG. 1 and the like described above includes the connector code 5; therefore, the communication unit 12 transmits information to the voice information processing apparatus 100 via the connector code 5. It may be possible to adopt a configuration in which the communication unit 12 is able to communicate with the voice information processing apparatus 100 by radio.

The control unit 13 controls operation of the voice information acquisition apparatus 1. The control unit 13 is configured with a general purpose processor, such as a central processing unit (CPU), or a dedicated integrated circuit, such as an application specific integrated circuit (ASIC) or a field programmable gate array (FPGA), that implements a specific function. The control unit 13 may include an artificial intelligence circuit and may perform control using a result of machine learning, such as deep learning, if needed. Various functions included in the voice information acquisition apparatus 1 are realized using a circuit that performs various kinds of control through specific sequence control in cooperation with a dedicated circuit or a program. Further, if the control unit 13 includes an artificial intelligence circuit, the control unit 13 is provided with a function to perform control using a result of machine learning. For example, the control unit 13 may acquire voice information with increased accuracy by performing machine learning.

The recording unit 14 records filter information 14a that is information on the multi-layer filter 7. Further, the recording unit 14 records various programs used by the control unit 13 to control operation. The recording unit 14 is configured with a volatile memory, such as a random access memory (RAM), and a non-volatile memory, such as a read only memory (ROM), for example. The RAM may temporarily store therein voice information collected by the voice collection unit 3. The recording unit 14 may be configured with a computer-readable recording medium, such as an externally-attachable memory card.

Next, a functional configuration of the voice information processing apparatus 100 will be described. The voice information processing apparatus 100 includes a communication unit 101, a clock unit 102, a voice output unit 103, a display unit 104, a control unit 105, and a recording unit 106.

The communication unit 101 transmits and receives information to and from the communication unit 12 of the voice information acquisition apparatus 1. The communication unit 101 transmits received voice information to the control unit 105.

The clock unit 102 transmits, to the control unit 105, a date and time at which the communication unit 101 received the voice information. The date and time recorded by the clock unit 102 is recorded by the control unit 105 into the recording unit 106 in association with the voice information.

The voice output unit 103 is configured with a speaker or the like that outputs voice. The voice output unit 103 may be configured separately from the voice information processing apparatus 100.

The display unit 104 displays information corresponding to a document 150 generated by a documenting unit 105b. The display unit 104 is configured with a display panel made with liquid crystal, organic electro luminescence (EL), or the like. The display unit 104 may be configured separately from the voice information processing apparatus 100.

The control unit 105 controls operation of the voice information processing apparatus 100. The control unit 105 includes a voice processing unit 105a and the documenting unit 105b.

The voice processing unit 105a performs voice processing, such as noise elimination processing, on the voice information received by the communication unit 101. For example, the voice processing unit 105a determines whether the voice information includes an environmental sound, such as wind noise, and eliminates, from the voice information, noise, such as an environmental sound, that is not needed when the voice information is converted to the text information.

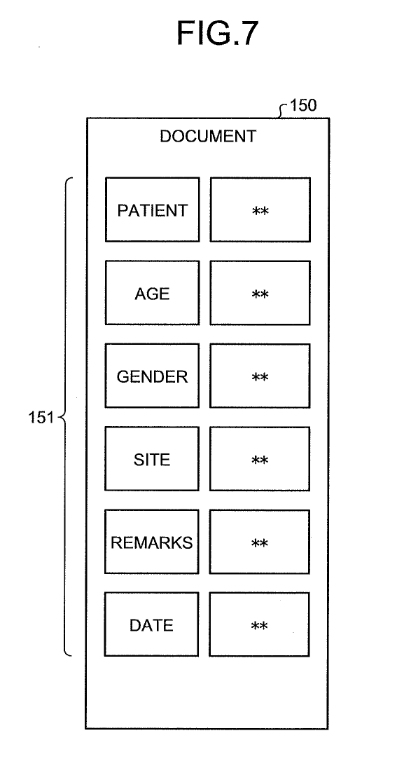

The documenting unit 105b converts the voice information, on which noise processing is performed by the voice processing unit 105a, to text information, and generates a document in accordance with a predetermined format. FIG. 7 is a diagram schematically illustrating a configuration of the document generated by the documenting unit 105b. The document 150 illustrated in the drawing includes a plurality of items 151, such as a “patient”, an “age”, a “gender”, a “site”, “remarks”, and a “date”. The document 150 generated by the documenting unit 105b is stored in the recording unit 106. The documenting unit 105b converts the voice information to the text information using a voice-to-text dictionary 106a stored in the recording unit 106.

The control unit 105 is configured with a general purpose processor, such as a CPU, or a dedicated integrated circuit, such as an ASIC or an FPGA, that implements a specific function. The control unit 105 may include an artificial intelligence circuit and may perform control using a result of machine learning, such as deep learning, if needed. Various functions included in the voice information processing apparatus 100 are realized using a circuit that performs various kinds of control through specific sequence control in cooperation with a dedicated circuit or a program. Further, if the control unit 105 includes an artificial intelligence circuit, the control unit 105 is provided with a function to perform control using a result of machine learning. For example, the control unit 105 may perform machine learning and register words in the voice-to-text dictionary 106a recorded in the recording unit 106 in order to increase vocabulary.

The recording unit 106 records information used for various kinds of processing performed by the control unit 105, the voice information received by the communication unit 101, and the like. The recording unit 106 stores therein the voice-to-text dictionary 106a, format information 106b, a document record 106c, and a voice processing table 106d.

The voice-to-text dictionary 106a is referred to when the documenting unit 105b converts the voice information to the text information as described above. The voice-to-text dictionary 106a includes a dictionary corresponding to words used in daily conversation. Further, when the voice processing system SYS is used for a medical purpose, medical terms are included in advance in the voice-to-text dictionary 106a.

The format information 106b is information on a format to be referred to when the documenting unit 105b generates the document 150. The format information 106b includes information on the items 151 or the like.

The document record 106c records the document 150 generated by the documenting unit 105b. The document record 106c may be recorded in a classifiable manner. For example, when the voice processing system SYS is used for a medical purpose, the recording unit 106 may configure the document record 106c such that the document 150 is associated with each of items, such as a patient and a diagnosis date.

The voice processing table 106d is a table indicating a processing status of the voice information received by the communication unit 101. The voice processing table 106d includes, for example, information indicating a progress status of conversion from the voice information to the text information, information indicating a progress status of document generation, or the like.

The voice information processing apparatus 100 having the above-described configuration is configured with one or more computers. When the voice information processing apparatus 100 is configured with a plurality of computers, the plurality of computers may be connected through wire so as to be able to communicate with one another, or may be connected via a communication network so as to be able to communicate with one another.

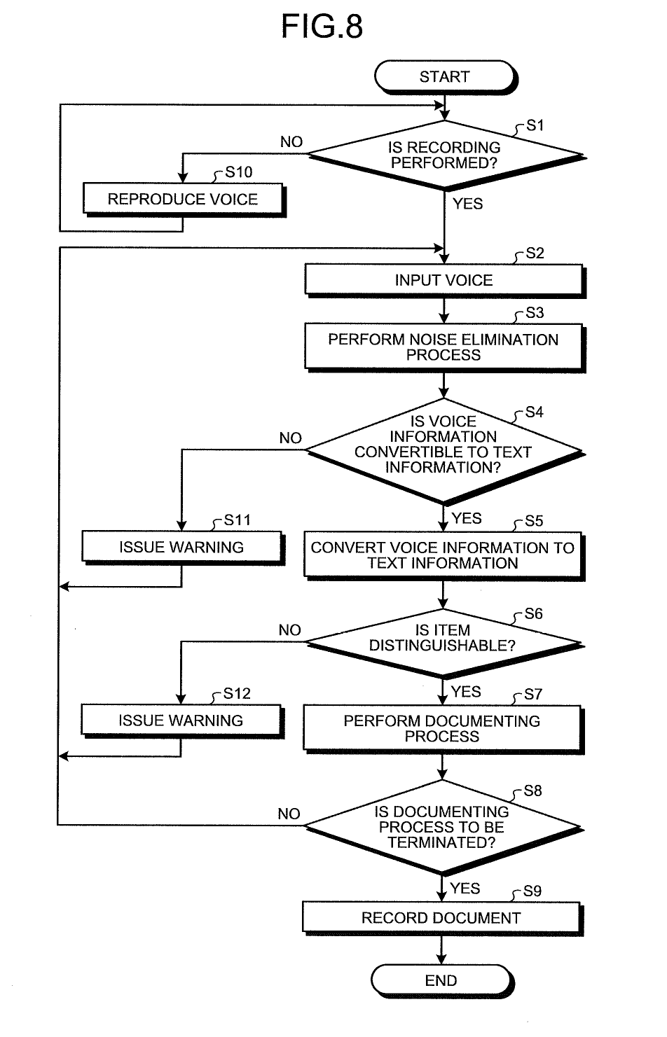

FIG. 8 is a flowchart illustrating an outline of a process performed by the voice processing system SYS. First, in the voice information acquisition apparatus 1, the control unit 105 determines whether recording is performed (Step S1). If it is determined that the recording is performed (Yes at Step S1), the voice information acquisition apparatus 1 receives input of voice information (Step S2). The communication unit 12 of the voice information acquisition apparatus 1 transmits the acquired voice information to the voice information processing apparatus 100 under the control of the control unit 13.

Subsequently, in the voice information processing apparatus 100 that has received the voice information, the voice processing unit 105a performs a noise elimination process on the voice information (Step S3).

Thereafter, the control unit 105 of the voice information processing apparatus 100 determines whether the voice information, from which noise is eliminated at Step S3, is convertible to text information (Step S4). As a result of determination, if the voice information is convertible to the text information (Yes at Step S4), the documenting unit 105b performs a process of converting the voice information to the text information (Step S5).

Subsequently, the control unit 105 determines whether an item corresponding to the text information among the items included in the document is distinguishable (Step S6). If the item corresponding to the text information is distinguishable (Yes at Step S6), the documenting unit 105b performs a documenting process of generating a document by inputting the text information in the corresponding item by referring to the format information 106b (Step S7).

Thereafter, the documenting unit 105b determines whether the documenting process is to be terminated (Step S8). In this case, the documenting unit 105b determines whether to terminate the documenting process based on an input status of the text information input in all of the items included in the format information 106b. If it is determined that the documenting process is to be terminated (Yes at Step S8), the documenting unit 105b records the generated document in the recording unit 106 (Step S9). The document 150 illustrated in FIG. 7 is one example of a completed document generated by the documenting unit 105b, and indicates a state in which corresponding text is written in all of the items. After Step S9, the voice processing system SYS terminates the series of processes.

At Step S1, if the control unit 105 determines that recording is not performed (No at Step S1), the voice output unit 103 of the voice information processing apparatus 100 reproduces the received voice (Step S10). Thereafter, the voice processing system SYS returns to Step S1. While a case has been described in which the voice is reproduced, the voice processing system SYS may be configured to perform a different process.

At Step S4, if the control unit 105 determines that the voice information is not convertible to the text information (No at Step S4), the control unit 105 displays a warning (including error information) indicating that conversion to text is not available on the display unit 104 (Step S11). It may be possible to cause the voice output unit 103 to output the warning by voice. After Step S11, the voice processing system SYS returns to Step S2.

At Step S6, if the control unit 105 determines that the item corresponding to the text information among the items included in the document is not distinguishable (No at Step S6), the control unit 105 displays a warning (including error information) indicating that the corresponding item is not distinguishable on the display unit 104 (Step S12). At Step S12, it is possible to cause the voice output unit 103 to output the warning by voice. After Step S12, the voice processing system SYS returns to Step S2.

At Step S8, if the documenting unit 105b determines that the documenting process is not to be terminated (No at Step S8), that is, if there is an item in which the text information is not input among the items of the document, the voice processing system SYS returns to Step S2.

In the description of the flowchart in this specification, context of the processes among the steps has been indicated using expressions, such as “first”, “thereafter”, and “subsequently”, but the sequences of the processes needed for implementing the present disclosure are not intended to be uniquely defined by these expressions. In other words, the order of processes in the flowchart illustrated in FIG. 8 may be changed within a range without contradiction.

According to the first embodiment as described above, the multi-layer filter 7 is provided, which is arranged on the front face of the casing 2 and includes a three-layer filter including at least the mesh-like first filter 71 located on the front face side and the mesh-like second filter 72 located on the side facing the microphone 8. Therefore, it is possible to acquire voice information with reduced pop noise.

Further, according to the first embodiment, the mesh opening of the first filter is greater than the mesh opening of the second filter; therefore, it is possible to prevent sebum dirt on the first filter on the front face from becoming visible.

Furthermore, according to the first embodiment, the multi-layer filter 7 is provided; therefore, it is possible to acquire clear voice even in an environment in which noise, such as an environmental sound, is present in addition to voice to be acquired.

Moreover, according to the first embodiment, the voice information acquisition apparatus 1 may acquire accurate voice information; therefore, the voice information processing apparatus 100 may generate a document by performing conversion to text information with high accuracy.

### Modifications

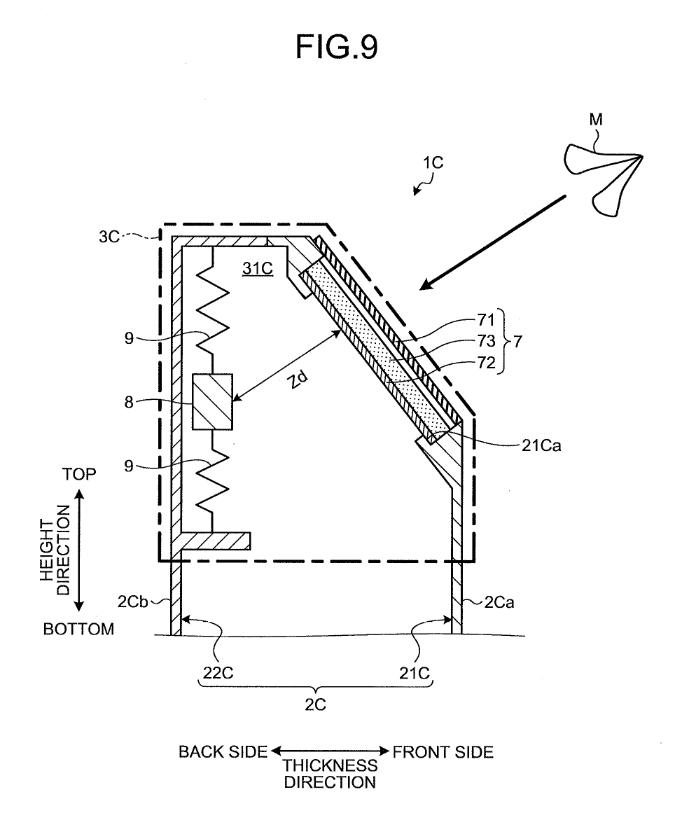

FIG. 9 is a partial cross-sectional view illustrating a configuration of a main part of a voice information acquisition apparatus according to a first modification of the first embodiment. In a voice information acquisition apparatus 1C illustrated in the drawing, the multi-layer filter 7 is arranged so as to be inclined with respect to the height direction of a casing 2C. In the voice information acquisition apparatus 1C, a filter housing recess 21Ca, in which the multi-layer filter 7 may be mounted so as to face obliquely upward, is provided on a first casing 21C. Specifically, the multi-layer filter 7 is inclined by about 45 degrees with respect to a front face 2Ca that is parallel to the height direction. The microphone depth Zd inside a housing part 31C is the same as that of the voice information acquisition apparatus 1 illustrated in FIG. 4 described above.

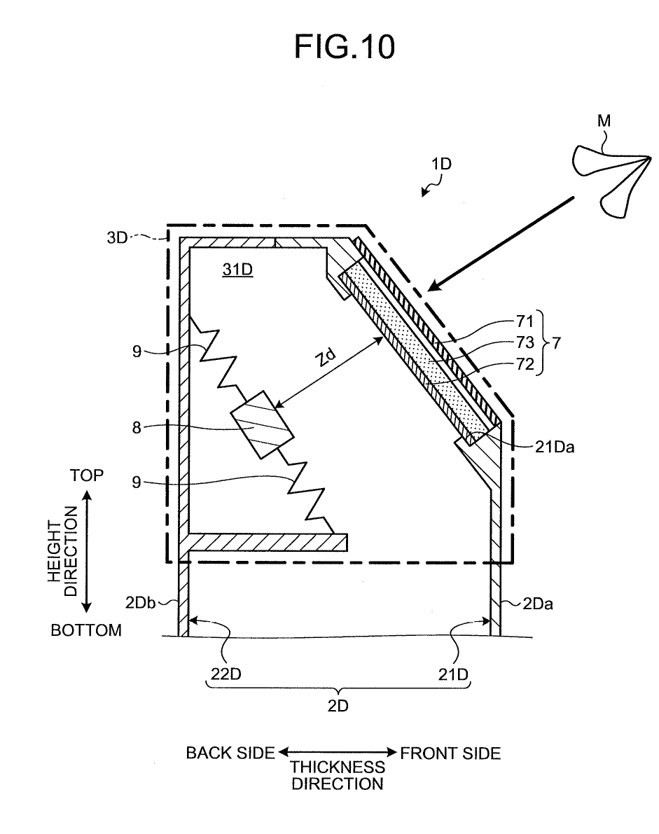

FIG. 10 is a partial cross-sectional view illustrating a configuration of a main part of a voice information acquisition apparatus according to a second modification of the first embodiment. A voice information acquisition apparatus 1D illustrated in the drawing is different from the voice information acquisition apparatus 1C illustrated in FIG. 9 in that the diaphragm of the microphone 8 is oriented in a different direction. In the voice information acquisition apparatus 1D, the diaphragm of the microphone 8 is inclined with respect to a front face 2Da of a first casing 21D of a casing 2D, and faces the principal surface of the multi-layer filter 7 mounted on a filter housing recess 21Da of the first casing 21D in a parallel manner. The microphone depth Zd inside a housing part 31D is the same as those of the voice information acquisition apparatuses 1 and 1C as described above.

According to the modifications as described above, the same effects as those of the first embodiment are achieved.

### Second Embodiment

Next, a second embodiment will be described. A voice information acquisition apparatus according to the second embodiment is different from the first embodiment described above in that it collects voice using two microphones. In the following description, the same components as those of the first embodiment described above are denoted by the same reference numerals, and explanation thereof will be omitted.

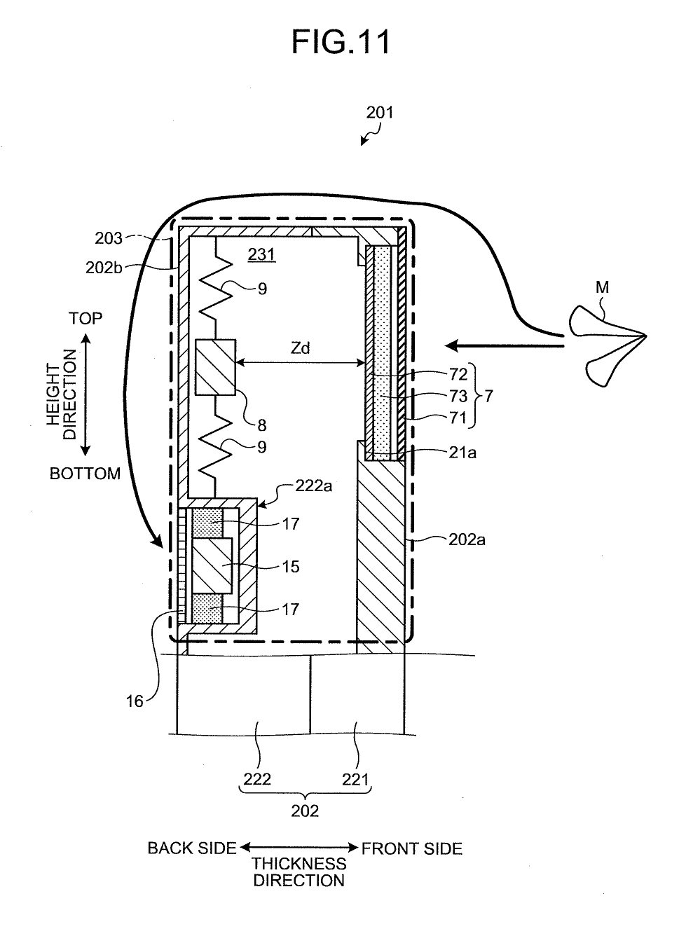

FIG. 11 is a partial cross-sectional view illustrating a configuration of a main part of the voice information acquisition apparatus according to the second embodiment. In a voice information acquisition apparatus 201 illustrated in FIG. 11, a voice collection unit 203 includes the multi-layer filter 7, the omnidirectional microphone 8 that faces a front face 202a side of a casing 202, and a microphone (second microphone) 15 arranged such that a diaphragm faces a back face 202b of the casing 202. The voice collection unit 203 generates voice information using voice acquired by each of the microphones 8 and 15.

The microphone 15 has a function to collect speaker's voice transmitted to the back face 202b side of the casing 202, and a function to eliminate noise, such as an environmental sound, around the voice information acquisition apparatus 201. The microphone 15 is spatially separated from a housing part 231 by a housing recess 222a of a second casing 222, and does not collect voice that propagates inside the housing part 231. The microphone 15 and the microphone 8 ensure directivity together with each other.

As illustrated in FIG. 11, the microphone 15 is housed inside the housing recess 222a. The microphone 15 is arranged on a lower side of the microphone 8 in the height direction and aligned with the microphone 8 along the height direction. With this configuration, it is possible to reduce a thickness of the casing 202.

The housing recess 222a has a shape that is recessed from the back face 202b side to the front face 202a side of the casing 202. A filter 16 for the microphone 15 (hereinafter, referred to as a “back side filter”) is mounted on the housing recess 222a. The back side filter 16 has a shape that conforms to the back face 202b of the casing 202. The back side filter 16 is made of a material different from a material of the multi-layer filter 7. The back side filter may be configured in the same manner as the multi-layer filter 7.

The microphone 15 is held by an elastic holding member 17 inside the housing recess 222a. The elastic holding member 17 is a member in the form of a hollow cylinder fitted to the housing recess 222a, and the microphone 15 is held in the hollow portion. Instead of providing a frame of the housing recess 222a to spatially separate the two microphones inside the casing, it may be possible to provide a member with excellent sound absorbability, such as polyester polyurethane foam, inside the casing 202 to spatially separate the microphone 8 and the microphone 15 from each other and prevent voice passing inside the casing 202 from being collected by the microphone 15.

The voice information acquisition apparatus 201 configured as described above and the voice information processing apparatus 100 described in the first embodiment constitute a voice processing system according to the second embodiment. In the second embodiment, the voice processing unit 105a of the voice information processing apparatus 100 eliminates external noise, such as an environmental sound, using the voice information acquired by the microphone 15, and generates a single piece of synthesized voice information by synthesizing two pieces of voice information based on a phase difference that is determined based on a positional relationship between the microphone 8 and the microphone 15. By using the phase difference generated by the microphone 8 and the microphone 15 of sound emitted from M and weakening the sound other than the phase difference, it is possible to increase the directivity and make the sound less noise. Further, the documenting unit 105b generates a document by converting the synthesized voice information to text information. The recording unit 106 records phase difference information on the two pieces of voice information that are to be referred to when the voice processing unit 105a synthesizes the two pieces of voice information, or the like.

According to the second embodiment as described above, it is possible to acquire voice information with reduced pop noise, similarly to the first embodiment.

In addition, according to the second embodiment, the microphone 15 is further provided on the back side; therefore, it is possible to reliably eliminate external noise and acquire more clear voice information (synthesized voice information). As a result, it becomes possible to convert the voice information to the text information with increased accuracy.

### Other Embodiments

While the embodiments for carrying out the present disclosure have been described, the present disclosure is not limited to the embodiments described above. For example, it may be possible to transmit a document generated by the voice information processing apparatus 100 to an external server via a communication network, and store the document in the external server.

Further, the voice information acquisition apparatus may be configured to have at least a part of the functions of the voice information processing apparatus. For example, the voice information acquisition apparatus may be configured to have a function to convert the voice information to the text information, and also have a function to generate a document.

Furthermore, processing algorithms described using the flowcharts in the present specification may be described as programs. Each of the programs may be recorded in a storage unit in a computer, or may be recorded in a computer-readable recording medium. The programs may be stored in the storage unit or recorded in the recording medium when the computer or the recording medium is shipped as a product, or may be stored or recorded by download via a communication network.

According to the present disclosure, it is possible to acquire voice information with reduced pop noise.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A voice information acquisition apparatus comprising:
a microphone configured to collect voice;
a casing configured to house the microphone inside thereof; and
a multi-layer filter arranged on a front face of the casing and including at least a three-layer filter that includes a mesh-like first filter arranged on a front face side and a mesh-like second filter arranged on a side facing the microphone.

2. The voice information acquisition apparatus according to claim 1, wherein the multi-layer filter and the microphone are separated from each other by a distance that is determined according to an effect that voice noise, which occurs when the multi-layer filter disperses and absorbs air, and voice, which has passed through the multi-layer filter, are attenuated with distance.

3. The voice information acquisition apparatus according to claim 1, wherein
a mesh opening of the first filter is greater than a mesh opening of the second filter, and
a wire diameter of the first filter is greater than a wire diameter of the second filter.

4. The voice information acquisition apparatus according to claim 1, wherein
the first filter and the second filter are configured with a metal, and
the multi-layer filter includes a third filter that is arranged between the first filter and the second filter and configured with a non-woven cloth.

5. The voice information acquisition apparatus according to claim 1, wherein the microphone is an omnidirectional microphone.

6. The voice information acquisition apparatus according to claim 1, further comprising:
an elastic holding member having elasticity and configured to hold the microphone inside the casing.

7. The voice information acquisition apparatus according to claim 1, further comprising:
a second microphone that is arranged on a surface opposite to a surface where the multi-layer filter is provided among surfaces of the casing, and that is spatially separated from the microphone inside the casing.

8. The voice information acquisition apparatus according to claim 7, wherein the second microphone is aligned with the microphone along a surface of the casing.

9. The voice information acquisition apparatus according to claim 1, wherein
the multi-layer filter is arranged on a surface in an upper end portion of the casing in a height direction, and
the casing includes a finger holder, on which a user's finger is held when a user holds the voice information acquisition apparatus, in an approximately central part of a surface thereof in the height direction, the surface located opposite the surface where the multi-layer filter is arranged.
